(19) United States
(12) Patent Application Publication
(10) Pub. No.: US 2017/0132719 A1
(43) Pub. Date: May 11, 2017

(54) DASHBOARD INTERFACE FOR ACCOUNT MANAGEMENT

(71) Applicant: CASHét Card LLC, Los Angeles, CA (US)

(72) Inventors: Paul Rogers, Los Angeles, CA (US); Kurt Woolner, Los Angeles, CA (US); Robbert Aarts, Leiden (NL)

(21) Appl. No.: 15/349,936

(22) Filed: Nov. 11, 2016

Related U.S. Application Data
(60) Provisional application No. 62/254,036, filed on Nov. 11, 2015.

(51) Int. Cl. G06Q 40/00; G06F 17/30; G06Q 20/10

(52) U.S. Cl. CPC G06Q 40/12; G06Q 20/10; G06F 17/30572

(57) ABSTRACT

A system for generating a flexible business-to-business virtual subaccount structure for a primary account. A dashboard server receives information of a primary account and generates a GUI to a user for monitoring expenditures. The dashboard server receives input from the user for creating two or more virtual subaccounts of the primary account. Information of the virtual subaccounts is stored in an account record database. The GUI displays information from the virtual subaccounts. The dashboard server monitors the virtual subaccounts based on rules established or assigned by the user. The dashboard server provides alerts to the user if any threshold of the rules is met or exceeded and may disable the virtual subaccounts if permitted.

### CROSS-REFERENCE TO RELATED APPLICATION

This is a nonprovisional patent application of provisional application Ser. No. 62/254,036, filed on Nov. 11, 2015. The disclosure thereof is incorporated by reference in its entirety herein.

### FIELD OF THE INVENTION

The invention relates to systems and methods for tracking and parsing data of multiple accounts in real time. Among other fields and applications, the invention has utility in facilitating monitoring account utilization including the ability to custom group data by user defined sub groupings (for example on a film account by budgeted departments such as Wardrobe or Set Dressing).

### DESCRIPTION OF RELATED ART

Keeping track of production costs when producing content, such as TV and film, is difficult. Well before a production is started, stakeholders typically set a budget for producing the content. When the stakeholders decide to approve a production, it is up to the interested parties to make sure that the production stays on budget. Film and TV productions, for instance, may need real time access to data to control spending. Complicating the issues of cost management is that multiple financial accounts may be used contemporaneously to make production-related expenditures and further complicating the cost management is the current lack of ability to segment spend within one financial account.

Existing systems for tracking spending across multiple accounts and within a large single account are deficient because they are built for typical corporate travel and entertainment credit card expense tracking, not project related costs. Credit card companies, for instance, may provide a website providing access to a listing of transactions made using a credit or debit account. Conventional websites, however, do not provide an interface built for production accounting or any project driven needs nor provide true integration with entertainment payroll accounting or other cost accounting systems. Improved systems are thus needed.

### BRIEF DESCRIPTION OF THE DRAWINGS

The invention may be better understood by reference to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 illustrates a block diagram of a system in accordance with example embodiments.

FIG. 2 depicts an a dashboard graphical user interface in accordance with example embodiments.

FIG. 3 depicts a new virtual subaccount creation screen in accordance with example embodiments.

FIG. 4 depicts an updated new virtual subaccount creation screen in accordance with example embodiments.

FIG. 5 depicts a virtual subaccount details message in accordance with example embodiments.

FIG. 6 illustrates a flow diagram of a method in accordance with example embodiments.

Persons of ordinary skill in the art may appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It may be further appreciated that certain actions and/or steps may be described or depicted in a particular order of occurrence while those skilled in the art may understand that such specificity with respect to sequence is not actually required. It may also be understood that the terms and expressions used herein are to be defined with respect to their corresponding respective areas of inquiry and study except where specific meanings have otherwise been set forth herein.

### DETAILED DESCRIPTION

Embodiments of present invention may be described more fully with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure may be thorough and complete, and may fully convey the scope of the invention to those skilled in the art. Among other things, embodiments of the invention may be embodied as methods, systems, computer readable media, apparatuses, or devices. Accordingly, an embodiment of the invention may take the form of an entirely hardware embodiment, an entirely software embodiment, or an embodiment combining software and hardware aspects. The following detailed description is, therefore, not to be taken in a limiting sense.

The example embodiments relate to systems and methods for providing a business-to-business (B2B) dashboard interface for tracking expenditures related to producing content or other projects. Examples of content include audio, video, multimedia, and the like. In many instances, an entity may create a budget for a production or project (e.g., a movie, television show, building project, etc.). To finance the production, the entity may obtain a line of credit or deposit a sum of money, and a primary account may be established to draw on that sum or line of credit. To keep track of spending, a primary account may be assigned a unique account identifier so that expenditures can be attributed to a particular primary account. Multiple subaccounts each having its own subaccount number may be associated with the primary account to permit authorized users to use the subaccounts to make purchases drawing on the primary account. A subaccount number may be assigned to a physical payment instrument (e.g., a physical credit card) or may be virtual payment instrument (e.g., a number without a physical card). A dashboard interface in accordance with example embodiments may permit a user to track spending in aggregate for the primary account and to monitor spending by individual subaccounts. Further customizable grouping of sub totals by department are also possible to create at the user's choice on the dashboard.

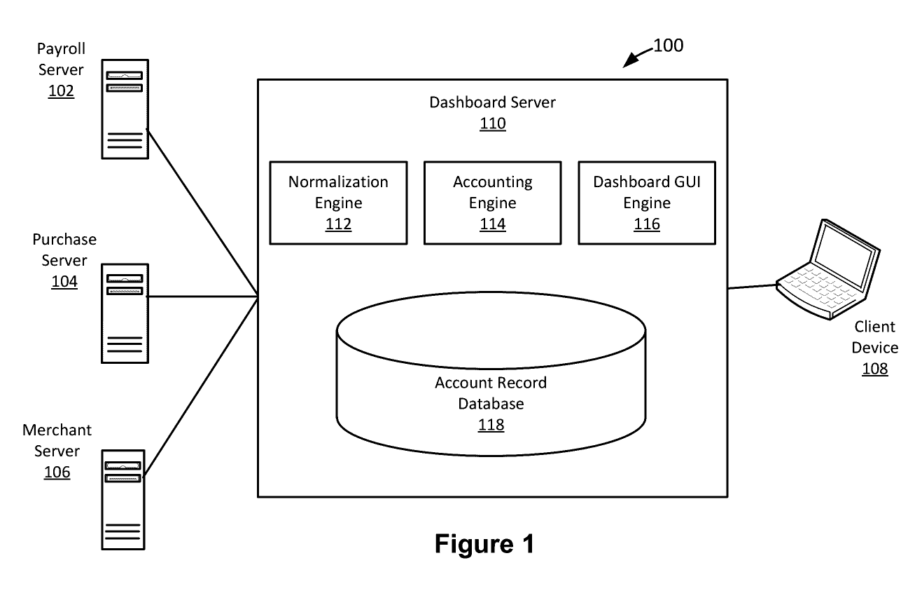

FIG. 1 illustrates a block diagram of a system 100 in accordance with example embodiments. System 100 may include a payroll server 102, a purchase server 104, a merchant server 106, and a client device 108 communicatively coupled to a dashboard server 110 by a direct connection or via one or more computer networks (e.g., local area network, wide area network, wireless network, wired network, and the like, and/or some combination thereof). Only a single instance of each component of system 100 is shown in FIG. 1. System 100, however, may have multiple instances of each component, some components may be omitted, or some components may be combined.

The dashboard server 110 may interact with the other servers to obtain expenditure data for tracking expenditures associated with a primary account, and may generate a dashboard graphical user interface presented to a client device 108 to enable a user to monitor those expenditures.

In an example, the payroll server 102 may maintain payroll data identifying wages paid to at least one employee working on production of a particular instance of content. For example, a studio may hire directors, writers, actors, crew, and the like, to work on a particular film. A payroll server 102 may track payment of the wages and periodically or occasionally communicate payroll data to the dashboard server 110. The payroll data may include an account identifier for identifying a particular primary account so that expenditures may be properly associated with a particular production. In some examples, the dashboard server 110 may contemporaneously track expenditures on multiple unrelated productions and keep expenditure data separate by allocating expenditures to particular primary accounts based on account identifiers.

A purchase server 104 may be operated by a financial company that provides the primary account and optionally one or more subaccounts to an entity associated with a production. In an example, the purchase server 104 may be operated by a credit card company or issuer. The purchase server 104 may communicate purchase data on purchases made for a production to the dashboard server 110. The dashboard server 110, as an B2B interface, may then manage and/or map the primary account to the one or more virtual subaccounts for the entity. The entity may then be a business wishing to receive services from the dashboard server 110. In one example, the dashboard 110 enable the entity to create virtual subaccounts based off the primary account for efficient and specific budge management without requiring an actual creation of a subaccount with the credit card company or the issuer. These virtual subaccounts were not established by the credit card company or the issuer and they have no control over the generations, deletions, controls, etc., of these virtual subaccounts. Moreover, rules or restrictions (to be described further below) established for the virtual subaccounts may be done individually or collectively for the virtual subaccounts. These rules or restrictions may be done without the knowledge of the credit card company or the issuer and, in the past, they would not be able to create such virtual subaccounts in their data structure organization without specifically opening a separate account (i.e., separate credit check, separate credit report/score, relationship between the different users, etc.) The purchase data may include an account identifier for identifying a particular primary account and optionally a particular subaccount so that purchases can be properly associated with a particular production and authorized user that made the purchase.

The merchant server 106 may maintain merchant invoice data on purchases made to support a particular production. Examples of merchant purchase data includes the costs to purchase or rent audio equipment, set pieces, food, real estate, and the like. The merchant data may include an account identifier for identifying a particular primary account and optionally a particular subaccount so that invoices can be properly attributed to a particular production and authorized user that made a purchase from the merchant.

The dashboard server 110 may process the received data from servers 102, 104, and/or 106 and create a dashboard graphical user interface (GUI) to provide a single interface by which a user may monitor expenditures associated with a particular production. The dashboard server 110 may serve the dashboard GUI to a client device 108 for display and for user interaction. In an example, the client device 108 may be a computer, a laptop, a mobile device, a smartphone, and the like.

When the dashboard server 110 receives data from any of servers 102, 104, or 106, the data may be processed by one or more engines of the server 110. In an example, the dashboard server 110 may include a normalization engine 112, an accounting engine 114, and a dashboard graphical user interface (GUI) engine 116. Each of engines 112, 114, and 116 may be discrete pieces of hardware hard coded to perform the functions described herein. In other examples, the functions of engines 112, 114, and 116 may be implemented in software as computer readable instructions stored in memory whereby execution of the computer readable instructions by at least one processor cause at least one computer, server, or other device, to perform the functions described herein. In yet other examples, any of the engines may implemented as discrete pieces of hardware and others may be implemented in software. In further examples, some functions performed by an engine may implemented as one or more discrete pieces of hardware and other functions may be implemented in software.

In an example, the normalization engine 112 may normalize data received from any of servers 102, 104, or 106. Data normalization may refer to the process of formatting received data into a consistent format that can be processed by other engines of the dashboard server 110.

The accounting engine 114 may process the normalized data to create accounting data and store the accounting data in accounting records in an account record database 118. When creating the accounting data, the accounting engine 114 may associate the normalized data with a particular production. To do so, each production may retrieve from the retrieved data its account identifier (e.g., an alpha-numeric sequence) for attributing the data to a particular production. An accounting record for a particular production may include all expenditures that have been associated with a particular production identifier and what user made those expenditures.

In an example, the dashboard GUI engine 116 may receive a request for a dashboard GUI from a client device 108. In an example, a user of client device 108 may identify a production of interest by production identifier and device 108 may communicate a request including the account identifier to the dashboard server 110. The dashboard GUI engine 116 may search the account record database 118 using the received account identifier for retrieving an account record associated with the account identifier. The dashboard GUI engine 116 may process the account record to retrieve the accounting data associated with the identified account record to generate the dashboard GUI. The dashboard GUI engine 116 may generate and communicate dashboard data to the client device 108 for presenting a dashboard GUI.

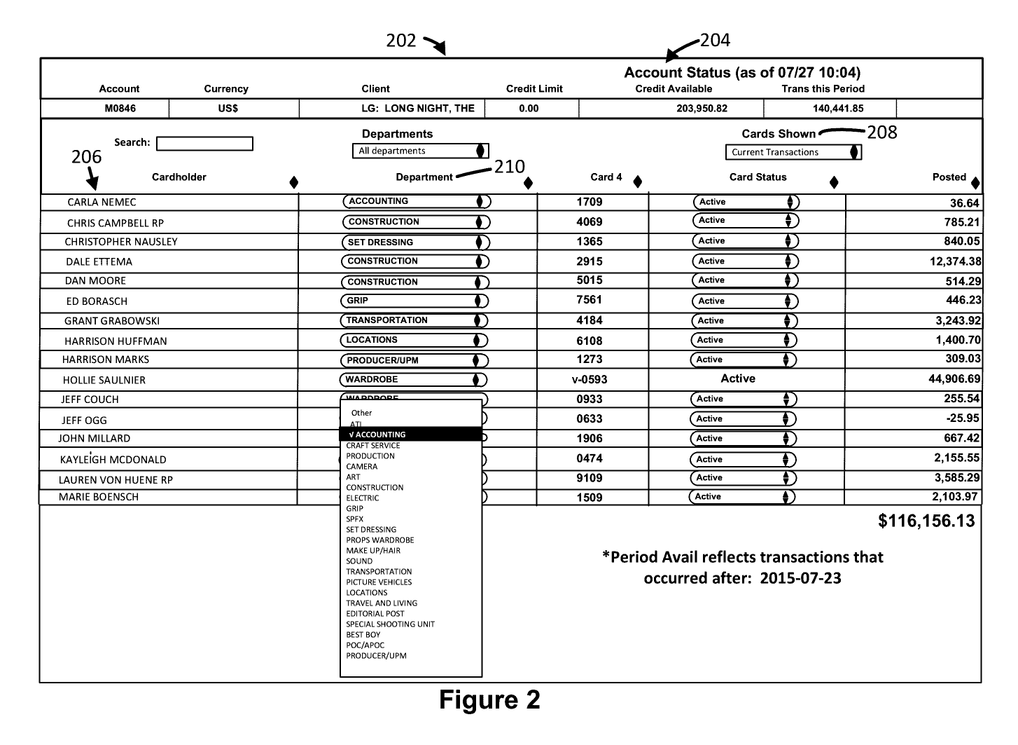

FIG. 2 illustrates a dashboard GUI 202 in accordance with example embodiments. The dashboard GUI 202 may be an interactive display (e.g., an interactive webpage) for presenting expenditure data associated with a particular production. The dashboard GUI 202 may provide information (e.g., in real-time) on one or more of: a total amount of available credit for the primary account and any subaccounts, a total account balance for the primary account and any subaccounts, authorized users (e.g., cardholders), spend per subaccount, spending limits for the primary account and any subaccounts, available balance for the primary account and any subaccounts, spend per production department, and the like. The dashboard GUI 202 may also be used to perform maintenance (e.g., in real-time) on: subaccount activation and blocking, subaccount limit changes, and ordering of new subaccounts. The following describes a subaccount as being a credit card. Other payment instruments instead of or in addition to a credit card may also be used as a subaccount.

The dashboard GUI 202 may include an account status 204 that provides an overall status of the primary account based on information presented in multiple fields. An Account Field may list some or a portion of the account identifier for the primary account. The Client Field may include a name of the entity creating the production. The Credit Limit Field may depict an overall credit limit for the primary account established by deposit or line of credit. The overall account credit limit may indicate the total amount of funds that of the primary account that are available to spend. The Credit Available Field is the total amount of credit available for the primary account. The Transactions (Trans) This Period field may show the total expenditures for all transactions for the primary account since a last invoice.

The dashboard GUI 202 may also display subaccount data 206 to permit tracking of individual subaccounts associated with the primary account. The dashboard GUI 202 may present the subaccount data 206 in a table having multiple fields and each row in the table corresponds to a particular subaccount. Each subaccount may correspond to a physical payment instrument (e.g., a credit card) or may be virtual payment instrument. A Cardholder Field may include a name or other identifier of a user who is authorized to use a particular subaccount. Selection of the Cardholder Field for a particular subaccount may be used to change who is the authorized user and/or to add or remove authorized users. Selection of the Cardholder Field may also list restrictions or rules on a subaccount. Restrictions or rules may include: (1) a spending limit for a single transaction or during a predetermined amount of time (e.g., per day, per week, etc.); (2) a transaction limit indicating the total number of transactions that can be made using the subaccount during a predetermined amount of time; (3) any merchant type restrictions identifying what merchants the subaccount can and/or cannot be used at (e.g., can shop at department stores but not gas stations); and (4) any geographic restrictions on use of the subaccount (e.g., can only spend within certain zip codes, cities, states, etc.). A merchant type restriction may limit use of a subaccount to a specific merchant (e.g., Wal-Mart) or category of merchant (e.g., department stores). A department field may include a drop down menu permitting selection of a particular department.

A Cardnumber Field may display some or all of an alphanumeric subaccount identifier assigned to a particular subaccount. The Card Status Field may list a status of a particular subaccount. In an example, the Card Status Field may be a drop down menu where a user can set a status for a subaccount. A status may be set as, for example, Active, Blocked, or Fraud/Stolen. An Active Status may indicate that a subaccount is active and may be used for purchases. A Blocked Status may indicate that a subaccount is currently blocked and cannot be used for purchases. A Fraud/Stolen Status may indicate that a subaccount has been reported stolen and/or used for a fraudulent transaction. In some examples, once marked with a status of Fraud/Stolen, a subaccount may not be subsequently used. A Posted field may identify all transactions for a particular subaccount that occurred during a particular period of time.

In additional examples, the table may include a Pending Field to identify all transactions for a particular subaccount that have been submitted for payment but are waiting approval. Clicking on a particular cell in the Pending Field associated with a particular subaccount may cause a pop-up window to appear displaying some or all pending transactions for that subaccount, a merchant to be paid for each transaction, and a transfer status of each transaction. A transfer status may be, for example, submitted, approved, and declined. A submitted status may indicate that a transaction has been submitted for approval but has not yet been reviewed. An approved status may indicate that a transaction has been authorized for payment. A declined status may indicate that a transaction is not authorized for payment. A Total Field may identify a total expenditure amount of all transactions on a particular subaccount. Selection of the Total Field for a particular subaccount may cause appearance of a pop-up window providing additional information on each transaction included in the total amount. The pop-up window may display, for example, a table listing each transaction, merchant name, time of transaction, and the like. A Period Limit field may identify a maximum amount of expenditures that can be charged to a subaccount during a particular period of time. A user may select a particular subaccount to change the maximum (e.g., increase and/or decrease limit). A Period Available Field may identify an amount of credit available for a subaccount during a particular period of time. The Last Period Invoice may show the amount of expenditure associated with a preceding time period's invoice. The Payments (Pmnts) This Period field may show the total amount of any payments on the primary account made during a current period. The Account Balance Field may show the balance due on the primary account.

In some examples, a lowermost row of the table including subaccount data 206 may display totals for the fields described above (e.g., total amount of pending transactions). Totals may be determined based on the displayed subaccount data and/or based on all subaccounts even if some subaccounts cannot be currently displayed in the dashboard GUI 202 due to size restrictions of the client device 108.

The dashboard GUI 202 may also permit a user to view other information in addition to subaccounts currently having transactions during a particular time period. For example, the dashboard GUI 202 may include a Cards Listed Field 208. Field 208 may be a drop down menu permitting selection between different types of subaccounts. Examples of subaccount types are Current Transactions, Active, Blocked, All, Virtual, and Fraud/Stolen. Based on the selected subaccount type, the dashboard server 110 may search the account records and serve updated dashboard data to the client device 108 for updating the dashboard GUI 202. In an example, selection of Current Transactions updates the dashboard GUI 202 to display any subaccount with a pending or posted transaction during a current time period. Selection of Active updates the dashboard GUI 202 to display all subaccounts that are active. Selection of Blocked updates the dashboard GUI 202 to display all subaccounts that are currently blocked. Selection of All updates the dashboard GUI 202 to display all subaccounts regardless of status. Selection of Virtual updates the dashboard GUI 202 to display all virtual subaccounts (discussed in further detail below). Selection of Fraud/Stolen updates the dashboard GUI 202 to display all subaccounts that have been marked stolen or have been associated with a fraudulent transaction.

The dashboard GUI 202 may also permit a user to view department-specific information during a particular time period. In an example, a Department Field 210 may be a drop down menu permitting “attachment” of cards to various production departments. Examples of departments may be Accounting, Wardrobe, Set Decoration, Transportation, and the like. Based on the selected department, the spend on the payment instrument (e.g., card) attached to that department may be able to be isolated in reporting and when updated to the client device to allow for cost control.

The dashboard GUI engine 116 may also monitor spending and trigger alerts. In an example, a client device 108 may receive a dashboard software application from the dashboard server 110. In some instances, there is an Internet-centric challenge of how to alert a user about time-sensitive information and for establishing a network connection based on the alert. To do so, the dashboard GUI engine 116 may monitor expenditures and determine when to send an alert. For example, an expenditure by a particular department or total spend may exceed a threshold. In response to detecting that the threshold has been exceeded, the dashboard GUI engine 116 may generate and communicate an alert to the client device 108 (e.g., via a wireless communication channel) to activate the dashboard software application. In response to activation, the dashboard software application may cause the client device 108 to display the alert and may cause device 108 to establish a network connection for retrieving additional data from the data server 110.

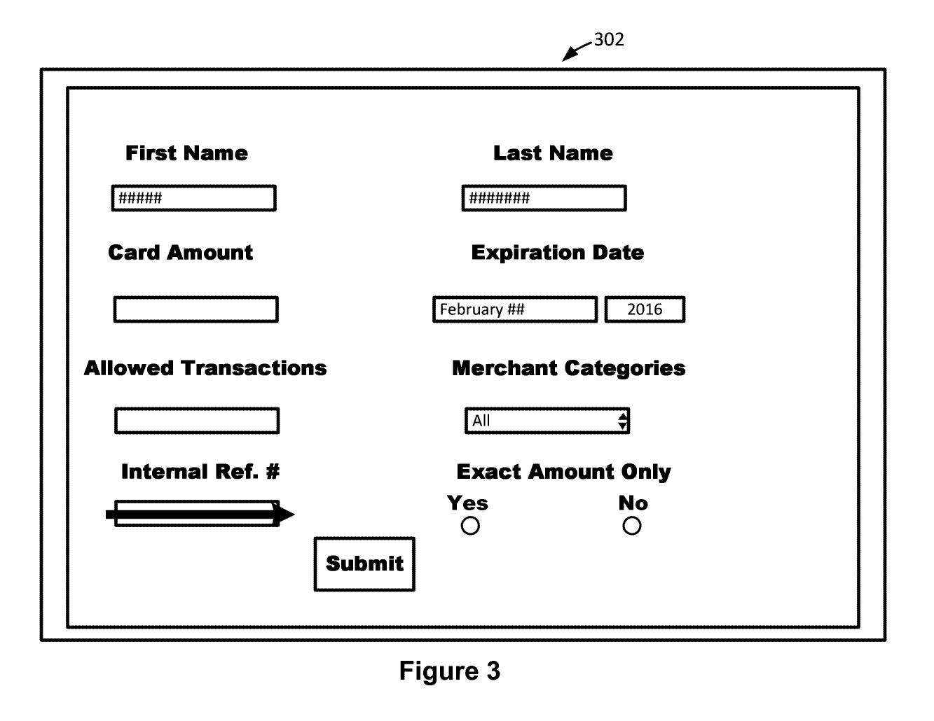

The dashboard GUI 202 may also be used to create virtual subaccounts. The following describes the virtual subaccount being a virtual credit card. To create a virtual credit card, a user may select an Order Card Field that may be displayed on dashboard GUI 202. In response to the selection, a new virtual subaccount creation screen 302 may appear on the client device 108, an example of which is shown in FIG. 3. A user may then populate in screen 302 the first and last name of the person creating or who is authorized to use the virtual card for purchases. A user may also enter in screen 302 the amount of the virtual subaccount. The amount may be the total amount that can be charged to the subaccount in a single transaction or over several transactions. Under allowed transactions a user may specify in screen 302 the total number of times a merchant is permitted to submit a charge to the virtual subaccount. For example, a merchant may submit a number of invoices for payment over time and may separately charge against the virtual subaccount when each invoice is due. A virtual subaccount can thus limit the number of times a virtual subaccount can be used and the total amount that can be charged to the virtual account.

Below are two detailed examples on types of virtual subaccounts that can be created. In a first example, a user may create a single use virtual credit card to pay a hotel bill for $10,543.27. With reference to FIG. 3, the user may input $10,543.27 as the Card Amount and “1” for Allowed transactions. Such a virtual card may only be good for one time use for an amount up to $10,543.27. In a second example, a user may create a virtual card to be used to pay multiple hotel bills for an amount not to exceed $15,000. With reference to FIG. 3, the user may input $15,000 as the Card Amount and “5” for Allowed transactions. Such a virtual card may only be good for up to five transactions which together cannot exceed $15,000. This gives the merchant (e.g., the hotel) some flexibility when charging to the virtual card, but protects the user by limiting the number of transactions and total amounts that can be charged to the card.

With reference again to FIG. 3, the Exact Amount Button may be used to control what amount can be charged to the virtual subaccount. If the Exact Amount Button is set as “yes” then the virtual subaccount can only be charged for the exact amount in a single transaction. If set to “no” any amount up to the Card Amount can be charged. The Internal Reference Number (Ref. #) field may permit the user to input information to assist in tracking expenditures. Any number, code, text, or information may be input by the user. An example of input information is a purchase order number. In other instances, the user may input a reference number or other information to enable the merchant to track use of the virtual card. The Expiration Date field may permit the user to specify an expiration date for the virtual subaccount. After the expiration date attempts to charge to the virtual subaccount may automatically be declined. The Expiration Date field optionally may have a default value (e.g., one month) that may be modified by the user. In some examples, a shorter expiration time period may provide more security.

The Merchant Categories field may be used to limit use of a virtual subaccount at only certain types of merchants. The Merchant Categories field may be a drop down menu listing permitted merchant types. In an example, the merchant types may be based on merchant category codes. Examples of merchant types include all merchants, airline merchants, business services, car rental merchants, financial service merchants, fuel merchants, hotel merchants, and the like. A user is not required to select a merchant type. If a merchant is not of the appropriate type, a charge request for that virtual subaccount may automatically be declined.

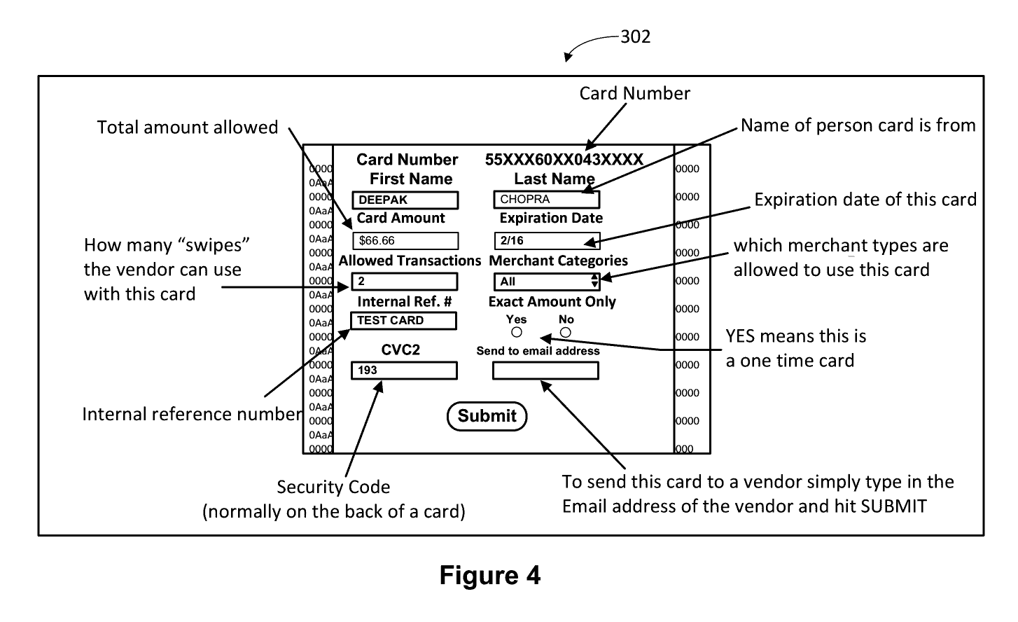

When a user has filled in the new virtual subaccount creation screen 302, the user may hit submit and the client device 108 may communicate a new card request to the dashboard server 110. If a virtual card can be created, the dashboard server 110 may communicate data to the client device 108 for updating the new virtual subaccount creation screen 302, as shown in FIG. 4. The updated new virtual subaccount creation screen 302 may include a number assigned to the virtual subaccount and a security code (e.g., CVV2 number, CVC2 number, and the like). In an example the assigned number may be a credit card number. The updated virtual subaccount creation screen 302 may also permit a user to input a virtual address (e.g., an email address) of a merchant for communicating the virtual card to the merchant. The client device 108 may communicate the virtual address to the dashboard server 110, which may communicate a virtual details message to the merchant. The merchant may use information contained in the virtual details message to submit a charge against the virtual subaccount.

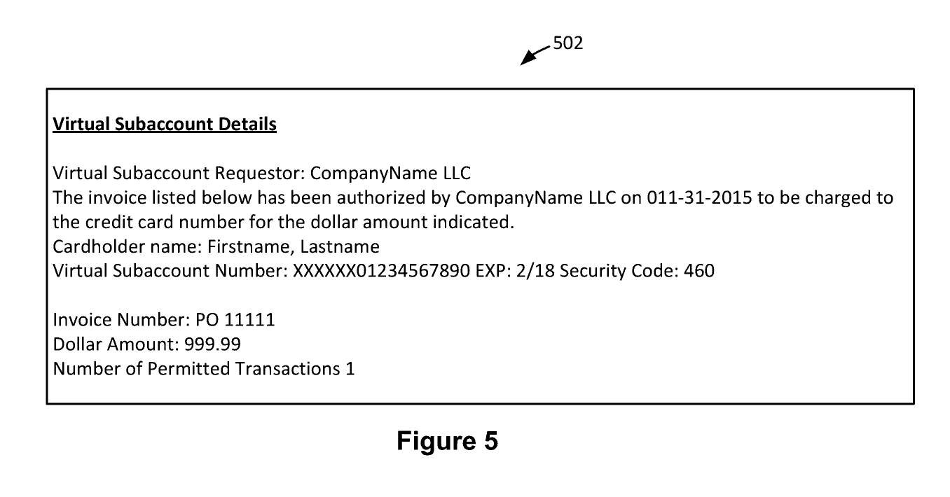

FIG. 5 provides an example of a virtual card details message in accordance with example embodiments. As depicted, the virtual card details message 502 may identify a name of the organization or person who requested creation of the virtual subaccount. The virtual card details message 502 may also list the name of a cardholder, a virtual subaccount number, an expiration date of the subaccount, a security code, invoice number, dollar amount, and number of permitted transactions. In some examples, only a portion of the virtual subaccount number may be provided to the recipient merchant for security purposes, and the virtual subaccount requestor may provide the remainder of the virtual subaccount number to the merchant in a separate communication and/or via a separate communication channel.

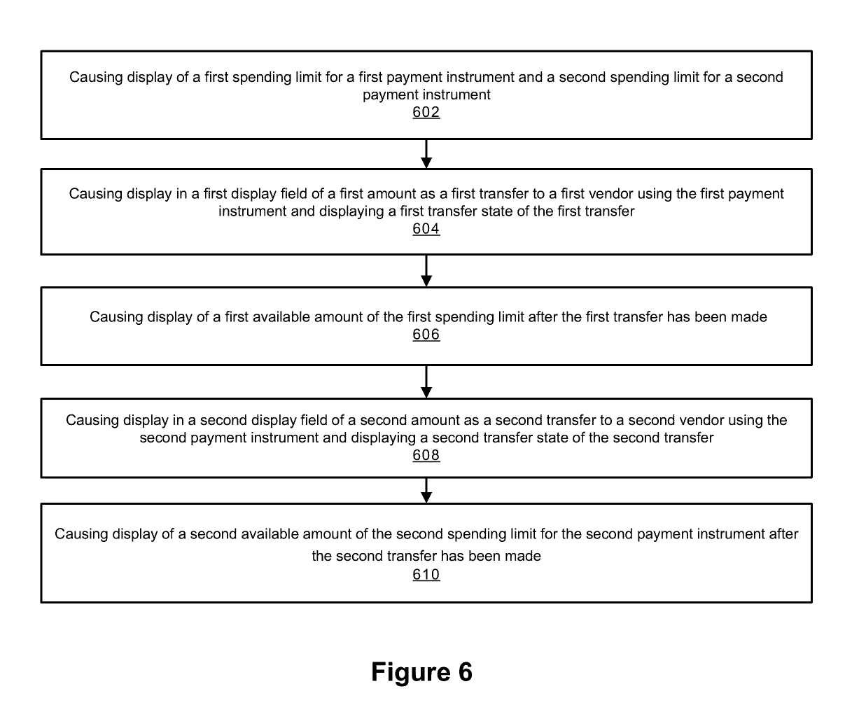

FIG. 6 illustrates a flow diagram of a method in accordance with example embodiments. The flow diagram may be implemented by a system or apparatus, such as, for example, dashboard server 110. Each of the blocks shown in the flow diagram may be repeated one or more times, one or more of the blocks may be modified, and one or more of the blocks may be omitted. The method may be stored on a non-transitory computer readable medium as computer executable instructions. The computer executable instructions, when executed by at least one processor, may cause at least one computer or other device to perform the blocks as steps of a method one or more times. The flow diagram may begin at block 602.

In block 602, the method may include causing display of a first spending limit for a first payment instrument and a second spending limit for a second payment instrument. In an example, the dashboard server 110 may generate dashboard data and communicate the data to the client device 108 for display of a dashboard GUI 202. The dashboard GUI 202 may display a Period Limit Field with a spending limit for each of multiple subaccounts. The subaccounts may be physical or virtual payment instruments.

In block 604, the method may include causing display in a first display field of a first amount as a first transfer to a first merchant using the first payment instrument and displaying a first transfer status of the first transfer. In an example, a user may select a cell in the Pending Field of the dashboard GUI 202. In response to the selection, the dashboard server 110 may generate dashboard data and communicate the data to the client device 108 for display of a dashboard GUI 202. The dashboard GUI 202 may display a pop-up window to display an amount to transfer to a merchant and a status of the transfer (e.g., submitted, authorized, declined).

In block 606, the method may include causing display of a first available amount of the first spending limit after the first transfer has been made. In an example, the dashboard GUI 202 may display a Period Available field displaying a remaining amount that can be charged to each subaccount. The remaining amount may be the difference between a credit limit and the total expenditures associated of all submitted and authorized transactions.

In block 608, the method may include causing display in a second display field of a second amount as a second transfer to a second merchant using the second payment instrument and displaying a second transfer status of the second transfer. In an example, a user may select a cell in the Pending Field of the dashboard GUI 202. In response to the selection, the dashboard server 110 may generate dashboard data and communicate the data to the client device 108 for display of a dashboard GUI 202. The dashboard GUI 202 may display a pop-up window to display an amount to transfer to a merchant and a status of the transfer (e.g., submitted, authorized, declined).

In block 610, the method may include causing display of a second available amount of the second spending limit for the second payment instrument after the second transfer has been made. In an example, the dashboard GUI 202 may display a Period Available field displaying a remaining amount that can be charged to each subaccount. The remaining amount may be the difference between a credit limit and the total expenditures associated of all submitted and authorized transactions.

The method of FIG. 6 may end, may repeat one or more times, or may return to any of the preceding blocks.

Advantageously, the example embodiments may facilitate management of expenditures throughout the course of a production and to create virtual subaccounts with desired attributes.

The computers and servers in FIG. 1 may be general purpose computers that may have, among other elements, a microprocessor (such as from the Intel Corporation, AMD or Motorola); volatile and non-volatile memory; one or more mass storage devices (i.e., a hard drive); various user input devices, such as a mouse, a keyboard, or a microphone; and a video display system. The computers and servers in FIG. 1 may be running on any one of many operating systems including, but not limited to WINDOWS, UNIX, LINUX, MAC OS, or Windows (XP, VISTA, etc.). It is contemplated, however, that any suitable operating system may be used for embodiments of the invention. The computers and servers in FIG. 1 may be a cluster of web servers, which may each be LINUX based and supported by a load balancer that decides which of the cluster of web servers should process a request based upon the current request-load of the available server(s).

The computers and servers in FIG. 1 are shown interconnected be lines. The lines may represent networks, including the Internet, WAN, LAN, Wi-Fi, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system 100 are examples. Any device depicted in FIG. 1 may communicate with any other device via one or more networks.

System 100 may include additional devices and networks beyond those shown. Further, the functionality described as being performed by one device may be distributed and performed by two or more devices. Multiple devices shown in FIG. 1 may also be combined into a single device, which may perform the functionality of the combined devices.

The various participants and elements described herein may operate one or more computer apparatuses to facilitate the functions described herein. Any of the elements in the above-described Figures, including any servers, user terminals, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that embodiments of the invention as described above can be implemented in the form of control logic using computer software in a modular or integrated manner. Based on the disclosure and teachings provided herein, a person of ordinary skill in the art may know and appreciate other ways and/or methods to implement embodiments of the invention using hardware, software, or a combination of hardware and software.

The above description is illustrative and is not restrictive. Many variations of the invention may become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it may be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated.

The present disclosure provides a solution to the long-felt need described above. In particular, systems and methods described herein may be configured to facilitate tracking of expenditures over the course of a production. Further advantages and modifications of the above described system and method may readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

What is claimed is:

1. A computer-implemented method for displaying a graphical user interface for virtual tracking expenditures associated with a production or project, the computer-implemented method comprising:
causing, by at least one processor, display of a first spending limit for a first payment instrument and a second spending limit for a second payment instrument;
causing, by the at least one processor, display in a first display field of a first amount as a first transfer to a first merchant using the first payment instrument and displaying a first transfer status of the first transfer;
causing display of a first available amount of the first spending limit after the first transfer has been made;
causing display in a second display field of a second amount as a second transfer to a second merchant using the second payment instrument and displaying a second transfer status of the second transfer; and
causing display of a second available amount of the second spending limit for the second payment instrument after the second transfer has been made.

2. The computer-implemented method of claim 1, further comprising causing displaying of a total of expenditures made using the first payment instrument and a total of expenditures made using the second payment instrument.

3. The computer-implemented method of claim 1, wherein the transfer status comprises at least one of submitted, approved, and declined.

4. The computer-implemented method of claim 1, wherein the first payment instrument is a virtual credit card.

5. The computer-implemented method of claim 4, wherein the first payment instrument comprises an account that has constraints which comprise at least one of a:
limited time;
limited use;
limited merchant;
limited merchant category; and
exact amount.

6. The computer-implemented method of claim 1, further comprising displaying at least one of:
total credit available;
total account balances; and
total spend and credit by department.

7. The computer-implemented method of claim 1, further comprising displaying authorized users of the first and second payment instruments.

8. The computer-implemented method of claim 7, wherein the authorized users may be modified.

9. The computer-implemented method of claim 7, wherein the transactions are broken out by authorized user.

10. The computer-implemented method of claim 1, wherein additional detail of a particular subaccount is displayed in an additional window by selecting a total.

11. The computer-implemented method of claim 1, further comprising displaying an input field to allow the first payment instrument to be marked as at least one of:
active;
blocked;
archived;
fraudulent; and
stolen.

12. The computer-implemented method of claim 1, further comprising displaying an input field to change a limit of the first payment instrument.

13. The computer-implemented method of claim 1, further comprising displaying at least one of:
the first available amount;
the second available amount;
the first spending limit; and
the second spending limit.

14. The computer-implemented method of claim 1, further comprising display at least one of:
one or more subaccounts with current transactions;
one or more subaccounts marked as being active;
one or more subaccounts marked as being blocked;
all subaccounts;
all virtual subaccounts;
one or more subaccounts marked as being associated with a fraudulent transaction; and
one or more subaccounts marked as being stolen.

15. The computer-implemented method of claim 1, further comprising causing display of at least one of:
a spending limit for a single transaction or for a predetermined amount of time;
a transaction limit indicating a total number of transactions permitted to be made during a predetermined amount of time;
a merchant type restriction; and
a geographic restriction.

16. The computer-implemented method of claim 1, further comprising causing display of an input field for ordering a new subaccount.

17. The computer-implemented method of claim 1, further comprising:
receiving a plurality of transactions; and
classifying each of the transactions into one of a plurality of primary accounts and a subaccount associated with a particular user.

18. The computer-implemented method of claim 1, further comprising displaying an input field for selecting a transaction to be exported
